(19) United States
(12) Patent Application Publication
(10) Pub. No.: US 2008/0033780 A1
(43) Pub. Date: Feb. 7, 2008

(54) SYSTEM AND METHOD FOR MANAGING TASKS THROUGH ELECTRONIC PORTABLE DEVICES

(75) Inventors: CHUNG-I LEE, Tu-Cheng (TW); CHIEN-FA YEH, Tu-Cheng (TW); CHIU-HUA LU, Tu-Cheng (TW); ZHI-QIANG JIANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/565,652

(22) Filed: Dec. 1, 2006

(30) Foreign Application Priority Data
Aug. 4, 2006 (CN) 200610061977.X

(51) Int. Cl. G06F 9/46

(52) U.S. Cl. 705/9; 713/182

(57) ABSTRACT

A system for managing tasks through electronic portable devices is disclosed. The system comprises at least one electronic portable device (1), a network server (3) coupled to the at least one electronic portable device (1) through a network, and a database (5) connected to the network server (3). The network server (3) comprises: an adapting module (100) for retrieving device spec of the electronic portable device (1), and sending and receiving data between the electronic portable device (1) and the network server (3); a verifying module (102) for verifying a username and a password sent from the electronic portable device (1); an obtaining module (104) for obtaining a list of tasks from the database (5) according to the username, and obtaining details of each task; and an updating module (106) for updating the database (5), and deleting the tasks which have been managed by the user of the electronic portable device (1) from the list of tasks. A related method is also disclosed.

### BACKGROUND OF THE INVENTION

1. Field of the Invention

The present invention generally relates to systems and methods for managing tasks, and more particularly, to a system and method for managing tasks through electronic portable devices.

2. Description of Related Art

Soon after the invention of computers, people began networking them. At first, connections between computers were established with cables. As technology advanced and needs demand for more flexibility, wireless communication methods were created and deployed. Early wireless communication techniques involved periodically connecting a computer to a network access point via a cable or via infrared signals between the computer and the network access point. These techniques require either attaching cables to the computer or placing an infrared port on the computer within a limited range of a corresponding infrared port at the network access point. Basically, early wireless communication techniques enabled computers to communicate with each other only within a limited physical range.

By the late twenties, wireless networks spanned much of the world, allowing computers to communicate from almost any location with each other or with remote computers hosting centralized data storage applications, or “data servers”. For example, using these communication networks, salespeople with wireless-modem equipped laptop computers can keep in touch with their companies' centralized inventory and ordering systems. Currently, people can manage their tasks by connecting their computers to their companies' mail servers, network servers, or any other remote servers.

Nonetheless, all the above tasks must be managed in virtue of communication between computers and servers. As a result, convenience and flexibility are undoubtedly decreased. Nowadays, many companies sense the potential advantage afforded by providing access from electronic portable devices such as smart phones to their systems or servers. Such companies hope to find a system or method, by which tasks can be managed just through electronic portable devices, so as to extent their business into wireless world. However, there is a lack of professional systems or methods which can achieve the above goal.

What is needed, therefore, is a system and method which can manage tasks just through electronic portable devices. Convenience and flexibility can be enhanced thereby.

### SUMMARY OF THE INVENTION

One preferred embodiment provides a system for managing tasks. The system includes at least one electronic portable device, a network server coupled to the at least one electronic portable device through a network and a database connected to the network server. The network server includes a verifying module, an obtaining module, an updating module and a judging module. The adapting module is configured for retrieving device spec of one of the at least one electronic portable device, and sending and receiving data between the at least one electronic portable device and the network server. The verifying module is configured for verifying a username and a password sent from the electronic portable device. The obtaining module is configured for obtaining a list of tasks from the database according to the username, and obtaining details of each task. The updating module is configured for updating the database, and deleting the tasks which have been managed by the user of the electronic portable device from the list of tasks.

Another preferred embodiment provides a method for managing tasks. The method includes the steps of: (a) retrieving device spec of a electronic portable device; (b) receiving a username and a password from the electronic portable device inputted; (c) verifying the username and the password, and obtaining a list of tasks from a database according to the username; (d) sending the list of tasks to the electronic portable device; (e) receiving a sequence number of the task to be managed selected by the user; (f) obtaining details of the task according to the sequence number, and sending the details to the electronic portable device; (g) receiving task management results sent from the electronic portable device by the user; (h) updating the database according to the task management results, and deleting the task which has been managed by the user from the list of tasks.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of hardware configuration and an application environment of a system for managing tasks through electronic portable devices in accordance with a preferred embodiment;

FIG. 2 is a schematic diagram of main function modules of the network server of the system of FIG. 1;

FIG. 3 is a flow chart of a preferred method for managing tasks through electronic portable devices by utilizing the system of FIG. 1;

FIG. 4 is a preferred user interface of logging in by using a Smartphone;

FIG. 5 is a preferred user interface of obtaining a list of tasks by using the Smartphone; and

FIG. 6 is a preferred user interface of viewing details of a task by using the Smartphone.

### DETAILED DESCRIPTION OF THE INVENTION

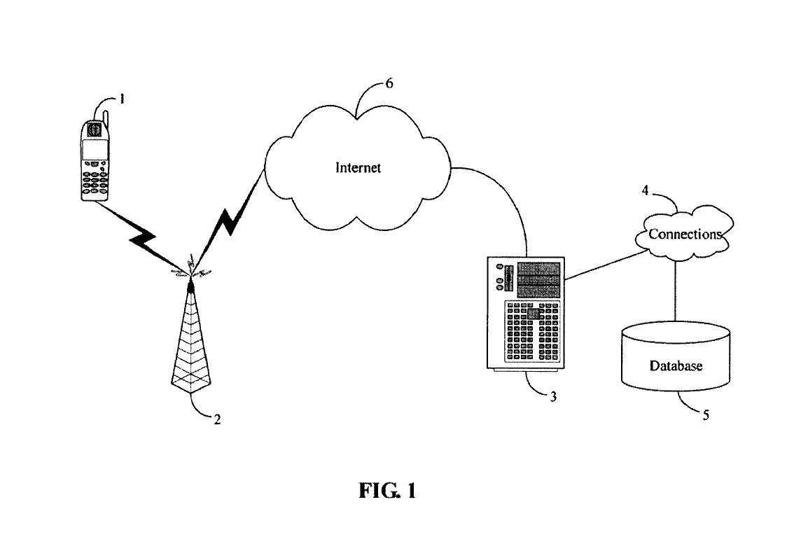

FIG. 1 is a schematic diagram of hardware configuration and an application environment of a system for managing tasks through electronic portable devices (hereinafter “the system”) in accordance with a preferred embodiment. The application environment may typically include at least one electronic portable device 1 (only one shown), a gateway 2, a network server 3, and a database 5. The at least one electronic portable device 1 communicates with the gateway 2 using S-HTTP (secure hypertext transfer protocol). The network server 3 is connected to the gateway 2 through the Internet 6, and is connected to the database 5 via a connection 4.

The electronic portable device 1 can be a smart phone, a personal digital assistant (PDA), or any other intelligent electronic portable device.

The gateway 2, which is generally provided by a mobile service carrier, is configured for routing and transmitting data. For instance, users can enjoy general packet radio service (GPRS) or any other service in virtue of the gateway 2.

The network server 3 can be a single server, or a group of servers. The connection 4 is a database connection that can be an open database connection (ODBC), or a Java database connection ODBC).

The database 5 is configured for saving usernames and corresponding passwords of authorized users of the system, a list of tasks to be managed by each user, details of each task, and so on.

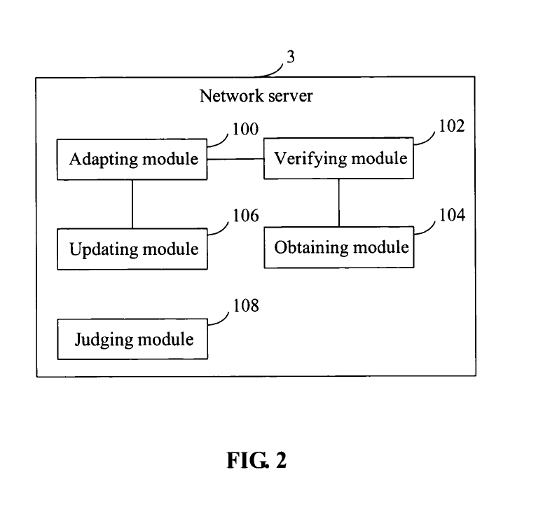

FIG. 2 is a schematic diagram of main function modules of the network server 3. The network server 3 mainly includes an adapting module 100, a verifying module 102, an obtaining module 104, an updating module 106, and a judging module 108.

The adapting module 100 is configured for retrieving device spec of the electronic portable device 1 when a user requests to manage tasks by using the electronic portable device 1. The device spec of the electronic portable device 1 mainly includes type of the electronic portable device 1, screen size of the electronic portable device 1, and ability of displaying characters and pictures, etc. The adapting module 100 is also configured for sending compatible display pages for the electronic portable device 1 according to the device spec retrieved.

The adapting module 100 is further configured for sending and receiving data between the electronic portable device 1 and the network server 3. The data may include username, password, list of tasks, sequence numbers of tasks, details of tasks, and task management results. The list of tasks includes sequence numbers and corresponding summaries of the tasks that the user can manage. In detail, the adapting module 100 receives a username and a password inputted by the user via the electronic portable device 1, and sends a corresponding list of tasks to the electronic portable device 1. The adapting module 100 then receives a sequence number of each task to be managed selected by the user, sends details of the task to the electronic portable device 1, and receives task management results.

The verifying module 102 is configured for verifying the username and the password received by the adapting module 100. In detail, the verifying module 102 searches for the received username in the database 5. If a same username can be found in the database 5, the verifying module 102 further checks whether a corresponding password in the database 5 is the same with the password received. If the two passwords are identical, the verifying module 102 returns “True,” and the user can log in the system successfully; otherwise, the verifying module 102 returns “False,” and the user is denied to log in the system.

The obtaining module 104 is configured for obtaining a list of tasks from the database 5 according to the username, when the verifying module 102 returns “True”. The obtaining module 104 is also configured for obtaining details of each task from the database 5 according to a sequence number of the task.

The updating module 106 is configured for updating the database 5 according to the task management results, and for deleting the tasks that have been managed by the user from the list of tasks.

The judging module 108 is configured for determining whether all the tasks in the list have been managed; and for prompting the user whether to continue managing the tasks if any tasks in the list have not been managed.

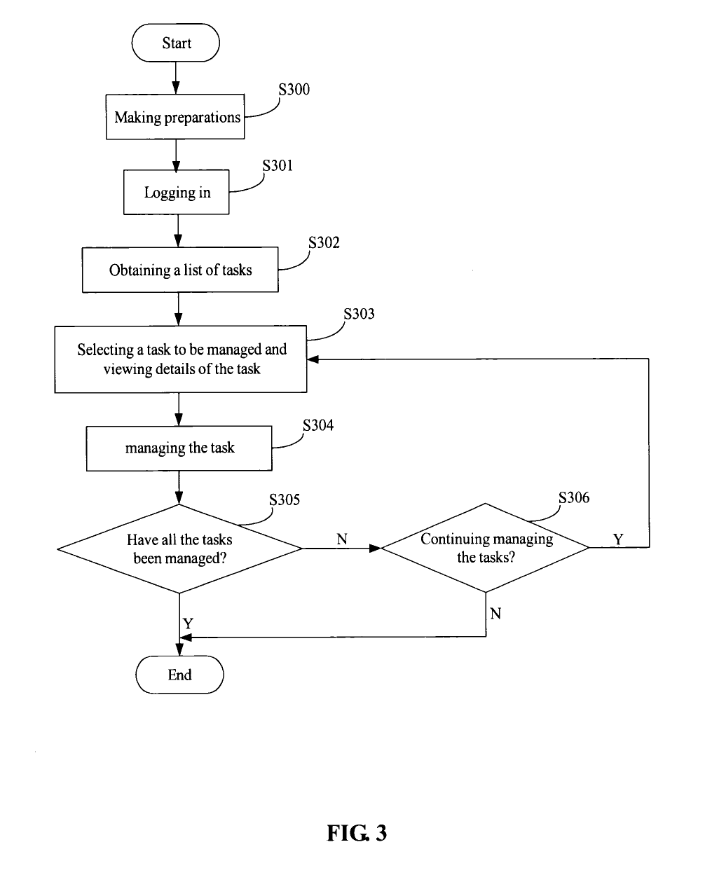

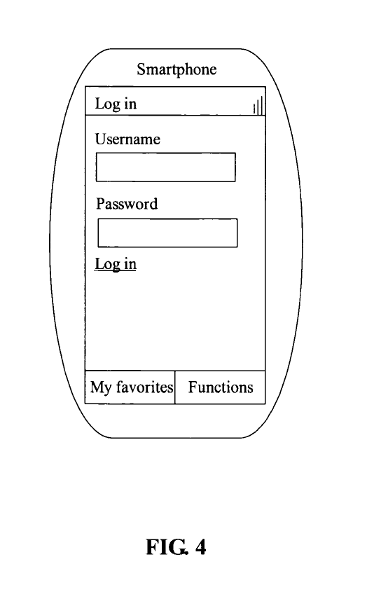

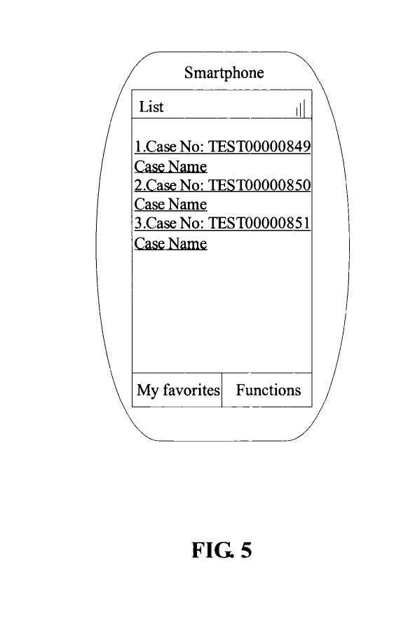

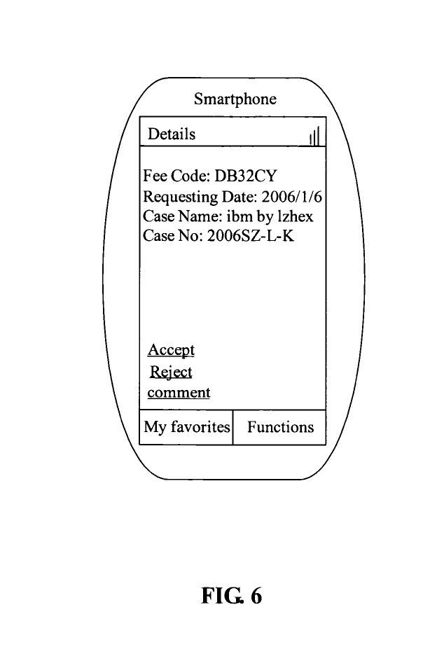

FIG. 3 is a flow chart illustrating a method for managing tasks through electronic portable devices. In this preferred embodiment, a smart phone shown in FIG. 4, FIG. 5, FIG. 6 (hereinafter “the Smartphone”) is utilized as the electronic portable device 1 in the method.

In step S300, the Internet service of the Smartphone is enabled in advance. When a user requests the system by using the Smartphone, the adapting module 100 retrieves device spec of the electronic portable device 1 such as type of the electronic portable device 1, screen size of the electronic portable device 1, and ability of displaying characters and pictures, etc. Then the adapting module 100 sends compatible display pages for the electronic portable device 1 according to the device spec.

In step S301, the user is required to input a username and a password (referring to FIG. 4) thru the electronic portable device 1. The adapting module 100 receives the username and the password, and the verifying module 102 verifies the username and the password received. In detail, the verifying module 102 searches for the received username in the database 5. If a same username is found in the database 5, the verifying module 102 further checks whether a corresponding password in the database 5 is the same with the password received. If the two passwords are identical, the verifying module 102 returns “True,” and the user can log in the system successfully; otherwise, the verifying module 102 returns “False,” and the user should input a username and a password once again.

In step S302, when the user logs in, the obtaining module 104 obtains a list of tasks from the database 5 according to the username. The adapting module 100 sends the list of tasks to the electronic portable device 1 (referring to FIG. 5). The list of tasks includes sequence numbers and corresponding summaries of the tasks that the user should manage.

In step S303, the user views the list of tasks on the Smartphone, and selects a hyperlink of a task to be managed in order to view details of the task. The electronic portable device 1 sends a sequence number of the task selected to the network server 3. The adapting module 100 receives the sequence number of the task selected. The obtaining module 104 obtains the details of the selected task from the database 5 according to the received sequence number, then the adapting module 100 sends the details of the task to the electronic portable device 1 (referring to FIG. 6).

In step S304, the user manages the task. For example, if the task requires the user to accept his underling's work, the user can agree by choosing “Accept”, or disagree by choosing “Reject”. The user can also express his opinions by choosing “Comment”. Then, the electronic portable device 1 sends the task management results to the network server 3. The adapting module 100 receives the task management results, the updating module 106 updates the database 5 according to the task management results received, and deletes the task that has been managed from the list of tasks.

In step S305, the judging module 108 determines whether all the tasks in the list have been managed. If all the tasks in the list have been managed, the procedure ends.

Otherwise, if any tasks in the list have not been managed, in step S306, the judging module 108 prompts the user whether to continue managing the tasks. If the user determines to continue managing the tasks, the procedure returns to step S303. Otherwise, if the user determines not to continue managing the tasks, the procedure ends.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A system for managing tasks comprising at least one electronic portable device, a network server coupled to the at least one electronic portable device through a network, and a database connected to the network server, the network server comprising:
an adapting module for retrieving device spec of one of the at least one electronic portable device, and sending and receiving data between the at least one electronic portable device and the network server;
a verifying module for verifying a username and a password sent from the electronic portable device;
an obtaining module for obtaining a list of tasks from the database according to the username, and obtaining details of each task; and
an updating module for updating the database, and deleting the tasks which have been managed by the user of the electronic portable device from the list of tasks.

2. The system according to claim 1, wherein the network server further comprises a judging module for determining whether all the tasks in the list have been managed, and prompting the user whether to continue managing the tasks if any tasks in the list have not been managed.

3. The system according to claim 1, wherein the device spec of the electronic portable device comprises type of the electronic portable device, screen size of the electronic portable device, and ability of displaying characters and pictures.

4. The system according to claim 1, wherein the data sent and received between the electronic portable device and the network server include username, password, list of tasks, sequence numbers of tasks, details of tasks and task management results.

5. A method for managing tasks, the method comprising the steps of:
retrieving device spec of an electronic portable device;
receiving a username and a password inputted by a user from the electronic portable device;
verifying the username and the password, and obtaining a list of tasks from a database according to the username;
sending the list of tasks to the electronic portable device;
receiving a sequence number of the task to be managed;
obtaining details of the task according to the sequence number, and sending the details to the electronic portable device;
receiving task management results sent from the electronic portable device; and
updating the database according to the task management results, and deleting the task which has been managed from the list of tasks.

6. The method according to claim 5, further comprising the steps of:
determining whether all the tasks in the list have been managed; and
prompting the user whether to continue managing the tasks if any tasks in the list have not been managed.

7. The method according to claim 6, further comprising the step of:
returning to the step of receiving a sequence number of the task to be managed, if the user determines to continue managing the tasks.
